(19) United States
(12) Patent Application Publication
(10) Pub. No.: US 2017/0096946 A1
(43) Pub. Date: Apr. 6, 2017

(54) IMPROVED FUEL INJECTION ARCHITECTURE

(71) Applicant: SAFRAN HELICOPTER ENGINES, Bordes (FR)

(72) Inventors: Pascal RIZZO, Pau (FR); Philippe Jean Rene Marie BENEZECH, Morlaas (FR)

(21) Appl. No.: 15/311,820

(22) PCT Filed: May 18, 2015
(86) PCT No.: PCT/FR2015/051282

§ 371 Date: Nov. 16, 2016

(30) Foreign Application Priority Data
May 19, 2014 (FR) 1454472

(51) Int. Cl. F02C 9/26; F23K 5/16; F23K 5/06; F02C 7/228

(52) U.S. Cl. CPC F02C 9/263; F02C 7/228; F23K 5/16; F23K 5/06; F23K 2203/105

(57) ABSTRACT

The invention relates to a turbine engine fuel injection architecture including: two fuel injection manifolds (30A, 30B), each manifold being suitable for dispensing a fuel flow to at least one associated injector; a main fuel-proportioning device (32) suitable for proportioning a total fuel flow (Q) to be supplied to at least both injection manifolds (30A, 30B); and a distribution proportioning device (31), located between the main fuel-proportioning device (32) and the injection manifolds (30A, 30B) and suitable for distributing at least part of the total fuel flow between both manifolds. The architecture is characterized in that it also includes a bypass valve (35) suitable for discharging a flow from a first manifold (30A, 30B) to a second manifold (30B, 30A), in the event of excess fuel pressure in the first manifold. The invention also relates to a turbine engine combustion assembly including said architecture.

### FIELD OF THE INVENTION

The present invention relates to a turbine engine fuel injection architecture, and to a combustion assembly comprising such an architecture.

### STATE OF THE ART

With reference to FIG. 1, a fuel injection architecture traditionally comprises at least two fuel injection manifolds 10_{A}, 10_{B}, each manifold may dispense a fuel flow to one or several fuel injectors (not shown).

The injectors associated with a given injection manifold are grouped according to their characteristics, like in particular their permeability or their injection technology.

Each injection manifold is supplied with a fuel flow Q_{A}, Q_{B}, which is a fraction of a total fuel flow Q issued by a main fuel meter 12, which meters this flow from a fuel source stemming from the fuel tank R of an aircraft in which the architecture is set up, the architecture being traditionally mounted on the engine, and the flow being extracted from the tank by one or several pumps (not shown). Indeed, the maximum acceptable flow rate in each manifold Q_{AMax}, Q_{BMax} is generally less than the maximum total fuel flow rate Q_{Max} issued from the main meter 12.

The fraction of the total flow dispensed at each injection manifold is, as for it, set by a distribution meter 11, positioned between the main fuel meter 12 and the manifolds 10_{A}, 10_{B}.

The distribution meter thus dispenses the total fuel flow between two or more manifolds, according to a determined distribution law.

In the example of FIG. 1, the architecture only comprises two fuel injection manifolds and the distribution meter dispenses the total flow among both manifolds in two metered flow rates Q_{A} and Q_{B} such that Q_{A}+Q_{B}=Q.

In FIG. 2a, an exemplary fuel distribution law is illustrated between the manifolds 10_{A} and 10_{B}, depending on a total flow rate set value sent to the main meter 12.

In this non-limiting example, for a total flow rate of less than a threshold value Qₛ, which preferably is less than or equal to the maximum acceptable flow rate in the manifold 10_{A} Q_{AMax}, the totality of the flow rate is dispensed to the manifold A for giving preference to this manifold (for example for promoting the use of the type of injectors associated with the manifold A). One therefore has the relationship: for 0<Q<Qs, Q_{A}=Q, Q_{B}=0.

When the total flow rate is equal to the threshold flow rate value, the distribution meter dispenses the flow between the manifolds A and B (point O₁₁ in the figure). One then has the relationship: for Q_{S}<Q<Q_{Max}, Q_{A}<Q_{AMax} and 0<Q_{B}<Q_{BMax}, and Q_{B}=Q_{BMax} for Q=Q_{Max}.

In each injection manifold, the pressure difference on the terminals of the injection manifolds A and B increases very substantially with the flow rate, since the pressure difference is typically related with the relationship:

Upstream pressure−Downstream pressure=Ka′*Qa² for the manifold A,
Upstream pressure−Downstream pressure=Kb′*Qb² for the manifold B,
with Ka′ and Kb′ being constants depending on the permeability of the manifolds and of the injectors for a fluid of given specific gravity.
The metering systems are designed so as to be able to operate at the highest possible injection pressure, which typically corresponds to the maximum flow rate of each manifold.

Now, an abnormality may occur in the operation of the distribution meter 11, so that the provided flow rate distribution law is no longer observed. For example, the distribution meter may be found blocked in a position where it issues a 100% of the total flow Q towards the manifold A, in which case the flow rate Q_{A} in the manifold A may be greater than the maximum flow rate Q_{AMax}.

In this case, an increase in pressure occurs in the manifold A which is passed onto the distribution meter 11 and then to the main meter. The main meter is typically associated with a device for protection against overpressures such as an overpressure valve 13. In the case of overpressure in the main meter 12, the valve 13 opens by sending back the flow rate upstream of the metering system. The flow leaving the main meter 12 is then reduced, which reduces the pressure generated by the manifolds. The main flow rate law is then no longer observed.

In FIG. 2b, the effective distribution of the flow between the injection manifolds is illustrated, depending on a total flow rate set value sent to the main meter 12.

When the controlled total flow exceeds the threshold flow Q_{S} for which the distribution meter 11 should normally distribute a portion of the flow towards the injection manifold B, the totality of this flow is directed towards the manifold A, which causes overpressure in this manifold, which rises up to the main meter 12 and causes the opening O₁₃ of the overpressure valve 13 for reducing the flow rate in this manifold.

It is therefore ascertained that the malfunction of the distribution meter 11 implies that the total flow issued to the injectors is less than the total flow rate set value sent to the main meter. This reduced flow induces a loss of power of the turbine engine.

Therefore there exists a need for a system giving the possibility of maintaining the power of the turbine engine even in the case of a malfunction of the distribution meter.

### PRESENTATION OF THE INVENTION

The object of the invention is to propose a turbine engine fuel injection architecture which gives the possibility of maintaining the power of the turbine engine even in the case of malfunction of the distribution meter.

In this respect, the object of the invention is a turbine engine fuel injection architecture, comprising:

two fuel injection manifolds, each manifold being adapted for dispensing a fuel flow to at least one associated injector,

a main fuel meter, adapted for metering a total fuel flow to be issued to at least both injection manifolds,

a distribution meter, positioned between the main meter and the injection manifolds, and adapted for dispensing at least one portion of the total fuel flow between both manifolds,

the architecture being characterized in that it further comprises a bypass valve adapted for discharging a flow from a first manifold to a second manifold in the case of fuel overpressure in the first manifold.

Advantageously, but optionally, the architecture according to the invention may further comprise at least one of the following features:

the architecture further comprises a second bypass valve adapted for discharging a flow from the second manifold to the first manifold in the case of fuel overpressure in the second manifold.

the distribution meter is adapted for distributing the portion of the total fuel flow between both manifolds according to a distribution law in which, for a flow rate of less than a predetermined threshold flow rate, the totality of said flow is issued to the first injection manifold.

the first bypass valve discharges a fuel flow from the first to the second manifold when the pressure in the first manifold is greater than or equal to a pressure attained during the flow in the manifold of the threshold flow rate.

a bypass valve is a hydromechanical overpressure valve.

a bypass valve is of the electromechanical type.

The architecture further comprises a processing unit adapted for controlling the valve according to at least one parameter from among the group comprising a pressure difference between both manifolds, a speed of rotation of the turbine engine, an atmospheric air pressure, an air pressure at the output of one or several compressor stages of the turbine engine, a fuel pressure at the output of a low pressure pump of the turbine engine, a fuel pressure at the input of the high pressure pump of the turbine engine, an actual position of the main fuel meter, and an actual position of the distribution meter.

The architecture further comprises a pressure sensor in each of the first and of the second manifold, or a differential sensor adapted for measuring a pressure difference between the first and second manifold, and the processing unit is adapted for controlling the valve according to said pressure difference.

The architecture further comprises an overpressure valve associated with the main fuel meter, adapted for discharging a flow towards the upstream side of the main fuel meter relatively to the fuel flow in the case of overpressure between the main fuel meter and the distribution meter.

The object of the invention is also a fuel combustion assembly of the turbine engine comprising:

a fuel tank,

a fuel architecture according to the preceding presentation, in which the main fuel meter samples the total flow in the tank,

a fuel combustion chamber, and

a plurality of fuel injectors respectively supplied by either one of the injection manifold and adapted for injecting fuel into the combustion chamber.

The invention finally relates to a turbine engine, comprising a combustion assembly according to the preceding presentation.

The existence of a bypass valve discharging the flow from one manifold to the other gives the possibility of guaranteeing that in the case of overpressure in the first manifold related to a failure of the distribution meter, the flow may all the same be distributed between both manifolds, which gives the possibility of attaining a total flow injected into the combustion chamber equal to the total flow metered by the main meter.

Thus even if the distribution is faulty between both manifolds, the power of the turbine engine is preserved.

### DESCRIPTION OF THE FIGURES

Other features, objects and advantages of the present invention will become apparent upon reading the detailed description which follows, with reference to the appended figures, given as non-limiting examples and wherein:

FIG. 1, already described, schematically illustrates a fuel injection architecture according to the state of the art,

FIG. 2a, already described, illustrates an example of a fuel distribution law between two injection manifolds,

FIG. 2b, also already described, illustrates a distribution example between the manifolds in the case of malfunction of the distribution meter,

FIG. 3a schematically illustrates a fuel injection architecture according to an embodiment of the invention,

FIGS. 3b and 3c schematically illustrates a fuel injection architecture according to an alternative embodiment, with different types of valves,

FIG. 3d schematically illustrates a fuel injection architecture according to another embodiment,

FIG. 4 illustrates a distribution example of fuel between two injection manifolds in the case of malfunction of a distribution meter with an architecture according to an embodiment of the invention,

FIGS. 5a and 5b schematically illustrate a turbine engine and a combustion assembly comprising a fuel injection architecture according to an embodiment of the invention.

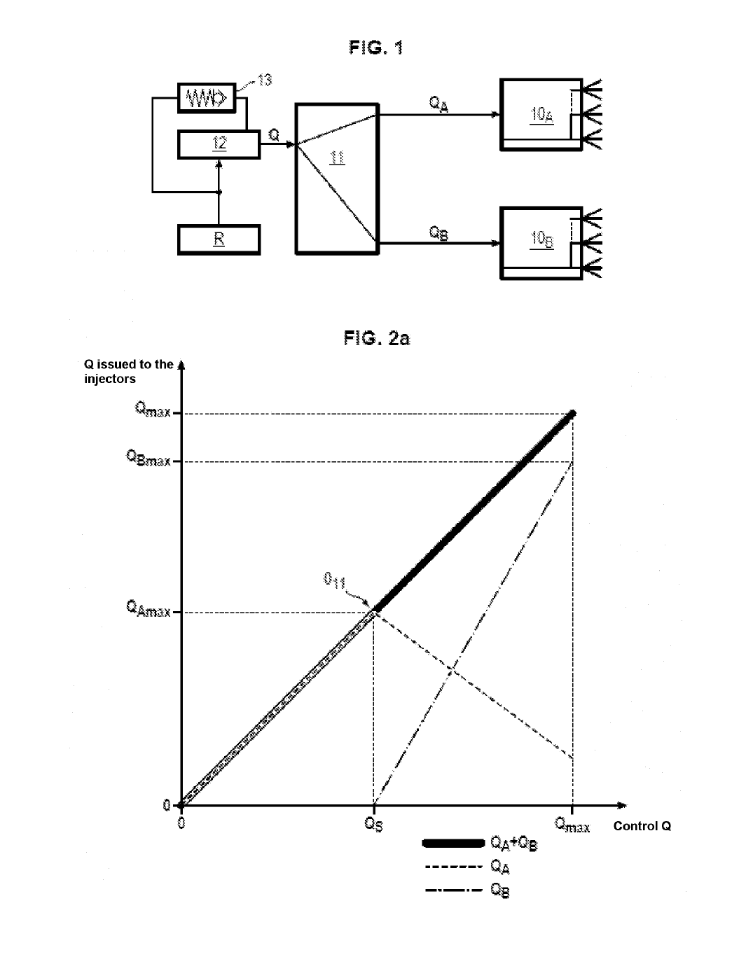

### DETAILED DESCRIPTION OF AT LEAST ONE EMBODIMENT

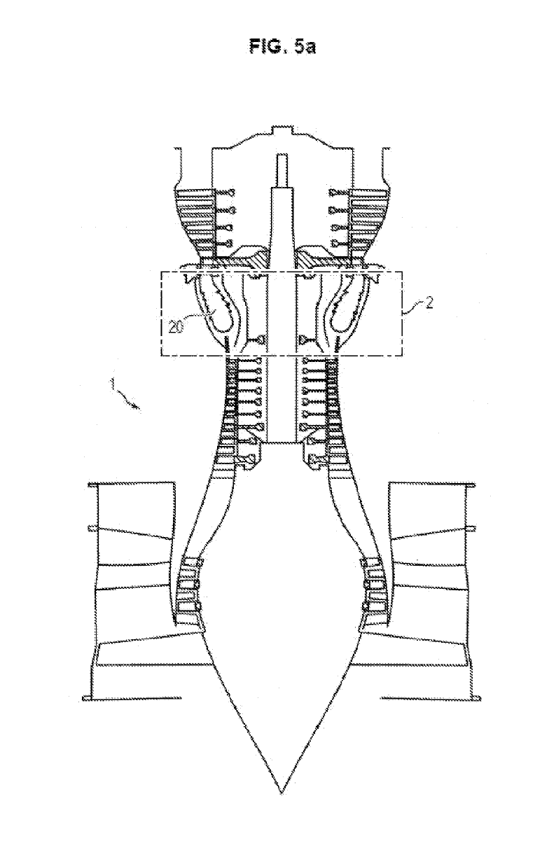

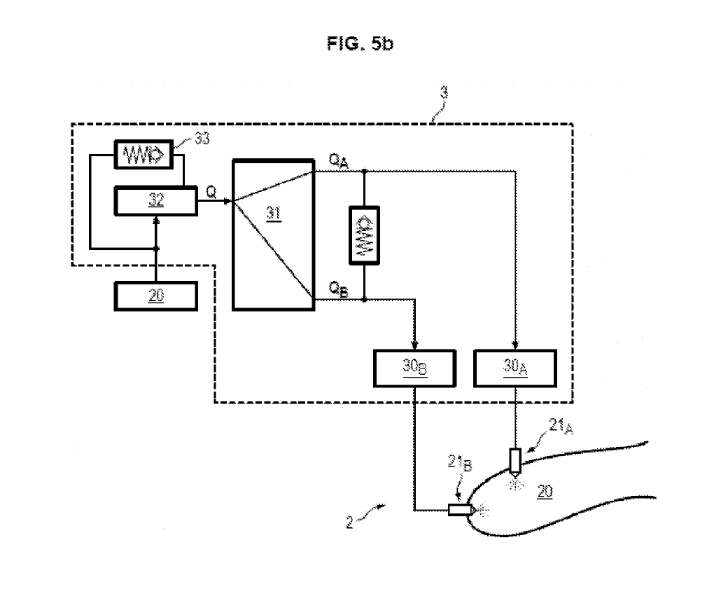

With reference to FIG. 5a, an example of a turbine engine 1 is illustrated comprising a combustion assembly 2 detailed in FIG. 5b.

The combustion assembly 2 comprises a fuel combustion chamber 20, as well as a plurality of injectors 21_{A}, 21_{B} (FIG. 5b) opening into the latter for injecting the fuel flow required for driving the turbine engine.

The combustion assembly further comprises a fuel tank R, and a fuel injection architecture 3 for supplying the injectors with fuel with the flow distribution desired for proper operation of the turbine engine.

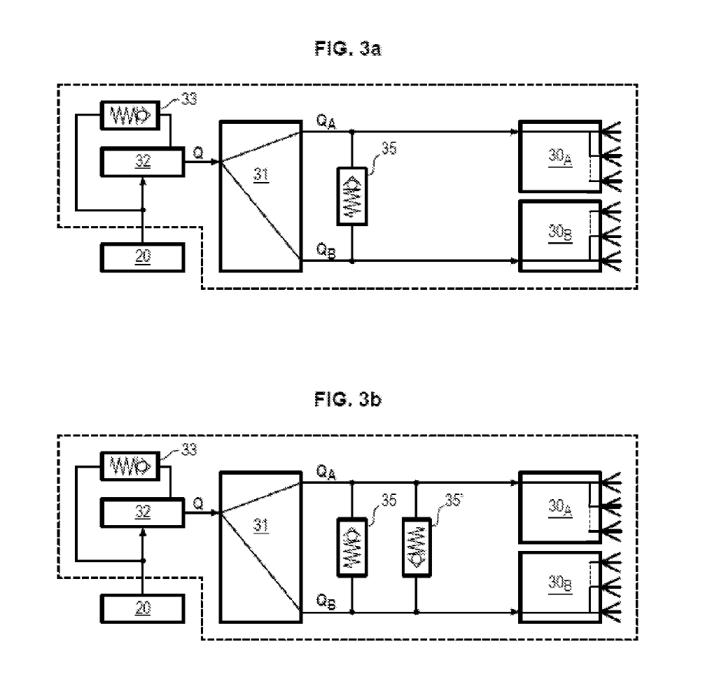

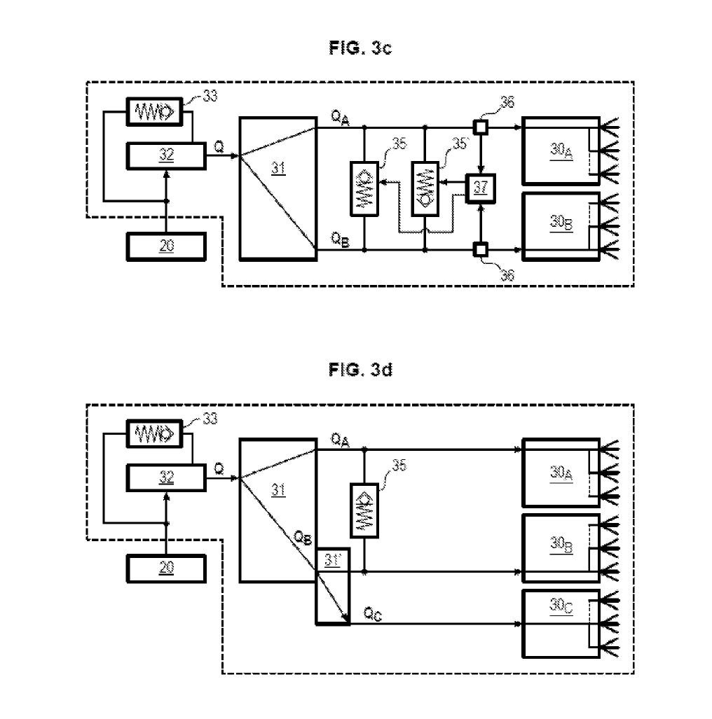

The fuel injection architecture 3 is described in more details hereafter with reference to FIGS. 3a to 3c.

It comprises a main meter 32, which is adapted for receiving fuel from the tank R (the fuel being sampled from the tank and sent to the meter by one or several pumps not shown) and for receiving a total flow Q to be dispensed to the injectors.

The architecture 3 further comprises at least two fuel injection manifolds 30_{A}, 30_{B}, two of which are specifically illustrated in FIGS. 3a and 3b, and a third one 30_{c} is also illustrated as an example in FIG. 3c.

Each fuel injection manifold 30_{A}, 30_{B}, 30_{c} issues a fuel flow Q_{A}, Q_{B}, Q_{C} to one or several injectors (not shown in FIGS. 3a to 3b), the injectors being associated with a determined manifold according to their characteristics, for example their permeability or their injection technology, so that the whole of the injectors associated with a same manifold ensures injection compliant to the need of the combustion chamber.

Thus, as a non-limiting example, the turbine engine may comprise an assembly of starting injectors, which are associated with spark plugs and give the possibility of initiating combustion in the chamber, and an assembly of main injectors, having a larger permeability, and intended to sustain the combustion in the chamber once that the latter is initiated.

According to this example, a first fuel injection manifold 30_{A} may dispense a fuel flow to the whole of the starting injectors and a second injection manifold 30_{B} may dispense a fuel flow to the whole of the main injectors.

However, this example is by no means limiting and other associations of injector assemblies with injection manifolds may be provided.

The injection architecture further comprises a distribution meter 31, positioned between the main meter 32 and the injection manifolds 30_{A}, 30_{B}, i.e. downstream from the main meter relatively to the fuel flow and upstream from the injection manifolds relatively to said flow. The total flow Q metered by the main meter is distributed by the distribution meter into two flows Q_{A} and Q_{B} respectively issued to the manifolds 30_{A} and 30_{B}.

In the case of malfunction of the distribution meter, and in order to avoid a power loss in the turbine engine, the architecture 3 further comprises at least one bypass valve 35 connecting together both manifolds 30_{A} and 30_{B}.

According to a first embodiment illustrated in FIG. 3a, the architecture comprises a single bypass valve 35, which is adapted for discharging a flow from a first manifold to a second manifold in the case of overpressure in the first manifold, thereby giving the possibility of limiting the pressure in the first manifold for limiting overpressure.

The operating direction of the valve is advantageously selected according to the distribution law normally adopted by the distribution meter 31, since this law determines which manifold is preferred for the injection of fuel, and therefore which manifold has a maximum probability of being found in overpressure in the case of malfunction of the distribution meter.

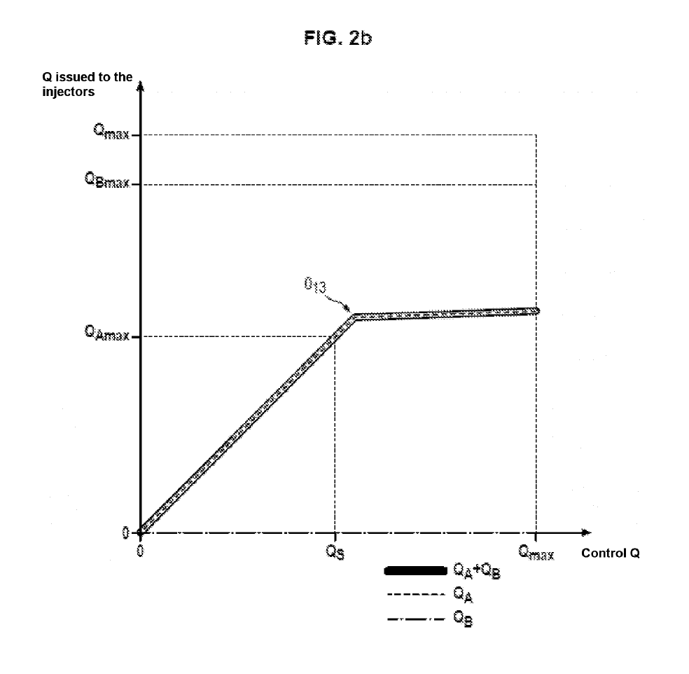

Thus, it is possible to take up again the example given previously with reference to FIG. 2a. In this non-limiting example, the distribution meter 31 gives preference to the manifold 30_{A} in the sense that the totality of the flow Q is sent towards this manifold, until the flow attains a determined threshold Q_{S}. Other distribution laws may be contemplated, in which for example the distribution meter divides the flow between both manifolds before the flow attains a given threshold in one of the manifolds.

If the distribution meter has a failure, preventing it for example from modifying its position, it is the manifold 30_{A} which may be rapidly found in overpressure since the global permeability of the corresponding injectors 21_{A} does not allow injection of the totality of the flow which they receive without exceeding the maximum acceptable pressure.

The bypass valve 35 is in this case advantageously positioned so as to discharge the manifold 30_{A} towards the manifold 30_{B} in the case of overpressure in the latter.

The valve 35 opens when the flow in the manifold 30_{A} causes pressure in this manifold such that the pressure difference between the manifold 30_{A} and the manifold 30_{B} exceeds a determined threshold. The corresponding flow rate is noted as Q_{threshold}. Preferably, this threshold is selected to be less than the maximum total flow rate Q_{Max}, and greater than or equal to the maximum flow rate in the manifold Q_{AMax}.

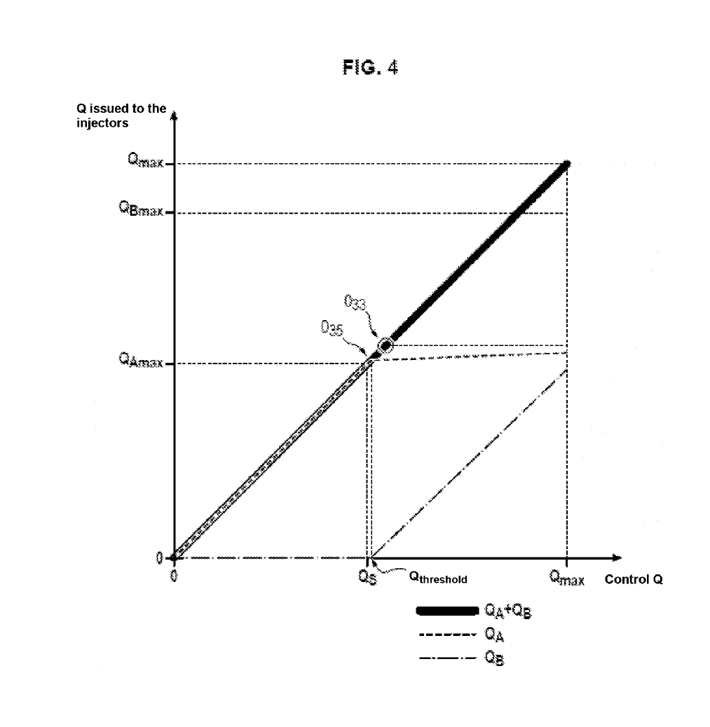

The distribution of flow between the manifolds 30_{A} and 30_{B} with the bypass valve 35 is illustrated in FIG. 4. It is thus ascertained that even with a failure of the distribution meter 31, the total flow is distributed between both manifolds and may however attain the maximum total flow rate Q_{Max} to be injected into the combustion chamber, thereby giving the possibility of preserving the power of the turbine engine.

More specifically in FIG. 4, when the total control flow attains the threshold flow Q_{threshold} corresponding to the opening O₃₅ of the valve 35, the latter opens for distributing a portion of the flow towards the manifold B.

As an additional safety measure, the injection architecture may also comprise an overpressure valve 33 associated with the main meter 32 and giving the possibility of sending back excess flow towards the upstream side of said meter, in particular in the case of fuel overpressure between the main meter 32 and the distribution meter 31. In this case, the threshold for opening the valve 35 is advantageously selected so that the latter opens before the valve 33: as visible in FIG. 4, the opening of the valve 35 takes place before attaining a flow level in the manifold A corresponding to a pressure which may cause opening O₃₃ of the overpressure valve 33.

With reference to FIG. 3b, an alternative embodiment is illustrated, comprising two bypass valves 35, 35′, positioned and staggered between both injection manifolds 30_{A}, 30_{B}, i.e. one valve is adapted for discharging a fuel flow from the manifold 30_{A} to the manifold 30_{B} in the case of overpressure in the manifold 30_{A}, and another valve 35′ is adapted for discharging a flow from the manifold 30_{B} to the manifold 30_{A} in the case of overpressure in the manifold 30_{B}. In this paragraph, by “overpressure in a manifold” is meant a pressure difference exceeding a determined threshold between the relevant manifold and the other manifold.

This configuration gives the possibility of overcoming all the types of malfunction of the distribution meter 31, even in the less likely cases when, the meter supplying in priority for example the manifold 30_{A}, it remains blocked in a position where it only supplies the manifold 30_{B}.

In this case, the second bypass valve 35′ allows discharge of the flow towards the manifold 30_{A} and therefore preserving a sufficient total flow in the combustion chamber for maintaining the power level of the turbine engine.

As illustrated in FIG. 3b, the bypass valve(s) 35′ are advantageously hydromechanical valves, i.e. valves for which the operation is purely mechanical and thus exclusively cause by a pressure difference exerted on a mobile element which opens when the pressure difference has attained a determined threshold. This type of valve has great reliability.

According to an alternative embodiment illustrated in FIG. 3c in the case when there are two bypass valves 35, 35′—but also applicable when there is only one of them—all or part of the valves used may be of the electromechanical type. A possible injection architecture then comprises pressure sensors 36 positioned in each manifold 30_{A}, 30_{B}, adapted for measuring the fuel pressure in each manifold, and a processing unit 36 connected to the sensors and to the valves, and configured for controlling the opening of each valve according to pressure values provided by the sensors.

Alternatively, the architecture may comprise, instead of the pressure sensors, a differential pressure sensor adapted for directly measuring a pressure difference between the manifolds, the processing unit controlling the opening of the valve from this pressure difference.

Alternatively, the processing unit 37 may control the opening of the valve from other parameters, optionally accumulated with the pressure difference, these parameters being advantageously selected from among the following group: one or several speeds of rotation of the turbine engine, atmospheric air pressure outside the turbine engine, air pressure at the output of one or several compressor stages of the turbine engine, fuel pressure at the output of a low pressure pump of the turbine engine, a fuel pressure at the input of a high pressure pump of the turbine engine, an actual position of the main fuel meter, and an actual position of the distribution meter. According to another alternative, the processing unit may use other signals related to the control of the engine and be integrated to a system for controlling the engine.

As a non-limiting example, the valve of FIG. 3a and those of FIG. 3b are hydromechanical valves, while the valves of FIG. 3c are electromechanical valves.

In the case when the injection architecture comprises more than two fuel injection manifolds, it may then comprise one other or several other distribution meters 31′ for distributing at each stage the upstream flow into two sub-flows, distributed either to the two injection manifolds, or to two distribution meters, or further to a distribution meter and an injection manifold.

An example of a configuration with more than two manifolds is illustrated in FIG. 3d, in which a distribution meter 31 dispenses the total flow Q between the injection manifold 30_{A} and a second distribution meter 31′, which itself dispenses the flow fraction received between the injection manifolds 30_{B} and 30_{C}.

In this case, the architecture 3 may comprise one or several bypass valves 35 downstream from one or several distribution meters, depending on the distribution laws of each meter as explained herein before. In FIG. 3d, a single bypass valve 35 is illustrated downstream from the first distribution meter 31.

The proposed architecture therefore gives the possibility of suppressing possible overpressures in the fuel injection manifolds while maintaining the power of the turbine engine.

1. A turbine engine fuel injection architecture, comprising:
two fuel injection manifolds, each manifold being adapted for dispensing a fuel flow to at least one associated injector,
a main fuel meter, adapted for metering a total fuel flow to be issued to at least both injection manifolds,
a distribution meter, positioned between the main meter and the injection manifolds, and adapted for dispensing at least one portion of the total fuel flow between both manifolds,
the architecture herein it further comprises a bypass valve adapted for discharging a flow from a first manifold to a second manifold in the case of fuel overpressure in the first manifold, and a second bypass valve adapted for discharging a flow from the second manifold to the first manifold in the case of fuel overpressure in the second manifold.

2. The fuel injection architecture according to claim 1, wherein the distribution meter is adapted for distributing the portion of the total fuel flow between both manifolds according to a distribution law in which, for a flow rate of less than a predetermined threshold flow rate, the totality of said flow is issued to the first injection manifold.

3. The fuel injection architecture according to claim 2, wherein the first bypass valve discharges a fuel flow from the first to the second manifold when the pressure in the first manifold is greater than or equal to a pressure attained during the flow in the manifold of the threshold flow rate.

4. The fuel injection architecture according to claim 1, wherein a bypass valve is a hydromechanical overpressure valve.

5. The fuel injection architecture according to claim 1, wherein a bypass valve is of the electromechanical type.

6. The fuel injection architecture according to claim 5, further comprising a processing unit adapted for controlling the valve according to at least one parameter from among the group comprising a pressure difference between both manifolds, a speed of rotation of the turbine engine, an atmospheric air pressure, an air pressure at the output of one or several compressor stages of the turbine engine, a fuel pressure at the output of a low pressure pump of the turbine engine, a fuel pressure at the input of a high pressure pump of the turbine engine, an actual position of the main fuel meter, and an actual position of the distribution meter.

7. The fuel injection architecture according to claim 6, further comprising a pressure sensor in each of the first and of the second manifold, or a differential sensor adapted for measuring a pressure difference between the first and second manifold, and the processing unit is adapted for controlling the valve according to said pressure difference.

8. The fuel injection architecture according to claim 1, further comprising an overpressure valve associated with the main fuel meter, adapted for discharging a flow towards the upstream side of the main fuel meter relatively to the fuel flow in the case of overpressure between the main fuel meter and the distribution meter.

9. A fuel combustion assembly of a turbine engine comprising:
a fuel tank,
a fuel architecture according to claim 1, in which the main fuel meter samples the total flow in the tank,
a fuel combustion chamber, and
a plurality of fuel injectors respectively supplied by either one of the injection manifold and adapted for injecting fuel into the combustion chamber.

10. A turbine engine, comprising a combustion assembly according to claim 9.
